(19) United States
(12) Patent Application Publication
(10) Pub. No.: US 2003/0065953 A1
(43) Pub. Date: Apr. 3, 2003

(54) Proxy unit, method for the computer-assisted protection of an application server program, a system having a proxy unit and a unit for executing an application server program

(75) Inventors: Dirk Lehmann, Munich (DE); Peter Trommler, Munich (DE)

Correspondence Address: STAAS & HALSEY LLP, 700 11TH STREET, NW, SUITE 500, WASHINGTON, DC, 20001, US

(73) Assignee: Siemens Aktiengesellshaft

(21) Appl. No.: 10/256,228

(22) Filed: Sep. 27, 2002

(30) Foreign Application Priority Data
Sep. 28, 2001 (DE) 101 47 889.5

(51) Int. Cl. H04L 9/00

(52) U.S. Cl. 713/201

(57) ABSTRACT

An application-layer-coded message is received in a proxy unit and is decoded on the basis of an application layer protocol format. A check is carried out to determine whether the decoded message satisfies at least one prescribed attack test criterion, and only the messages which do not satisfy the prescribed attack test criterion are transmitted to the application server program which is to be protected.

### CROSS REFERENCE TO RELATED APPLICATIONS

This application is based on and hereby claims priority to German Application No. 101 47 889.5 on Sep. 28, 2001, the contents of which are hereby incorporated by reference.

### BACKGROUND OF THE INVENTION

The invention relates to a proxy unit, to a method for the computer-assisted protection of an application server program, and to a system having a proxy unit and a unit for executing an application server program.

Normally, a multiplicity of computers coupled to one another via a telecommunications network, for example the Internet, communicate on the basis of a computer network architecture (communication model) which is split into a multiplicity of communication layers having tasks relating to the communication procedure which are each uniquely associated with the communication layers.

An example of such a layer model is the OSI reference model (Open System Interconnection reference model), which is described in A. S. Tanenbaum, Computernetzwerke (Computer Networks), Pearson study, ISBN 3-8273-7011-6, pp. 45-52, 2000.

On the basis of the OSI reference model, the following layers are defined for providing the entire communication between two application server programs which normally operate on two computers coupled to one another via the Internet:

layer 1: physical layer,

layer 2: data link layer,

layer 3: network layer,

layer 4: transport layer,

layer 5: session layer,

layer 6: presentation layer, and

layer 7: application layer.

The physical layer (layer 1) relates to the transmission of individual bits via a communications channel. The main task of the data link layer (layer 2) is to transform a “raw transport facility” into a line which presents itself to the network layer (layer 3) free of unidentified transmission errors. The network layer in turn relates to control of subnetwork operation, particularly the routing of data packets.

The transport layer (layer 4) has the fundamental task, when sending data, of accepting data from the session layer (layer 5), possibly of splitting them into smaller data units, and then of transferring them to the network layer and seeing to it that correct point-to-point communication with the destination computer is ensured.

The session layer allows users on different machines to set up sessions among one another.

The presentation layer (layer 6) performs particular functions whose frequent use justifies a general solution instead of leaving it up to every user to perform the associated tasks. A typical example of tasks in the presentation layer is the coding of data in a standardized and agreed manner, for example on the basis of Abstract Syntax Notation.1 (ASN.1).

Finally, the application layer (layer 7) represents the topmost layer in the OSI reference model.

Subsequently, application layer is understood to mean any layer within the context of a communication layer model which has no further layer above it to which it provides services. Hence, elements in the application layer provide no kind of services for a layer situated above said application layer, but rather only for programs or elements in the application layer itself.

Clearly, the application layer is that layer in which a user has the data from data transmission or remote data processing available directly. Functions within the application layer are, by way of example, functions which need to be performed for communication between open systems and which have not yet been performed by lower, further communication layers situated below the application layer.

The application layer contains programs (subsequently referred to as application server programs) which use provided services in the layers situated below for transmission. An example of such an application server program is a WWW browser program (World Wide Web browser program), which allows communication between a client computer and a server computer on the basis of the “HTTP protocol” (Hypertext Transfer Protocol).

Expressed another way, an application server program is intended to be understood to mean a server program which provides services based on a protocol for the application layer to a client application program, for example to a WWW browser program. Normally, an application server program additionally has procedures—expressed another way, program components—which can execute instructions based on the protocol for the application layer.

Other application server programs are, by way of example, programs which provide a directory service, for example naming services (directory services), that is to say which provide the name classification service and forwarding of the ascertained name classifications to requesting services, for example the determination of an address for a name, the determination of a distribution list or the determination of a server for a service within the context of a classified telephone directory.

These directory services can also be user-oriented. Other application server programs relate to terminals in which file transfer, access control or else computer network management (examples thereof are the SNMP (Simple Network Management Protocol) or the CMIP (Common Management Internet Protocol)). Furthermore, e-mail programs, that is to say programs which provide the service of sending electronic messages—also referred to as e-mail programs—are application server programs within the application layer.

Particularly in recent times, electronic commerce involves using the WWW server programs on the basis of the HTTP protocol to provide electronic commerce.

For this reason, however, today's WWW server programs installed on a WWW server computer are frequently a target for attack by computer-assisted attacks on the respective application server program, particularly also directly on the WWW server program.

Normally, to attack a server program on a web server computer, an attack program is used which uses the HTTP communication protocol to penetrate the e-commerce system provided by the WWW server program. The HTTP communication protocol and, associated therewith, the application server program in the application layer are unlocked across all protective barriers, that is to say it is not possible to use the known mechanisms to protect against attacks in a form decoded in line with the protocol for the application layer using the respective attack program. Such an attack program normally exploits weaknesses in the WWW server program, that is to say in the software of the respective web server computer, for example program errors.

To prevent such attacks, that is to say to provide a protective system for a web server, a firewall is normally used. However, a computer set up as a firewall allows attacks whose structure can be identified only in a form decoded on the basis of the application protocol format to pass by unfiltered, since the protective mechanisms of a firewall act only at the level of the transport layers (transport layer, network layer).

In addition, a network-based intrusion detection system (IDS) is known, although this can merely identify and report an attack but cannot prevent it.

In a host-based intrusion detection system, only modifications to a “protected system” as a result of an effected attack are reported, but again the attacks themselves cannot be prevented.

Weaknesses in an application server program, for example in a WWW server program, can often be eliminated or reduced by installing a patch, that is to say by installing an update program or part of a program as an update.

The patch is installed on the respective web server. A drawback of this practise is that a further application using the application server program is frequently able to run only on the original application server program, but is not compatible with the application server program including the added patch program—expressed another way, the updated application server program. In addition, a further application server program which normally uses the application server program is certified for a certain system level or for a prescribed application server program and, following the installation of the patch, that is to say of the patch program, would lose the certification and hence the manufacturer's assurance. Often, a manufacturer of a program or a hardware component using the application server program has not yet released its product for the application server program including the updating patch.

Another drawback of this solution is that such a patch program is often not available at all until after a certain elapsed period of time.

Alternatively, the weaknesses could be eliminated by switching off the system for its own protection.

A third option for eliminating the weaknesses involves restricting the communication between the programs which communicate with one another. This is often undesirable, however, and particularly also affects communication partners for which this problem situation does not actually apply. In addition, those communication partners which are still actually authorized to communicate with the application server program can indeed do so and can possibly unintentionally transmit such an attack program in the process or can unintentionally be transmitters of the respective attack.

It is also known practise to use antivirus software, that is to say antivirus programs, for protecting programs installed on a computer and for protecting the computer itself. Although such an antivirus program can identify viruses in the file system, it does not actually prevent a direct attack against the application server program and the web server.

In addition, U.S. Pat. No. 5,657,390 (“'390 patent”) describes the architecture of the security sockets layer (SSL) for the cryptographic protection of a server program in the application layer.

M. Payer, Computervermittelte Kommunikation (Computer-networked Communication), section 13, pp. 1-8, available on the Internet on Sep. 7, 2001 at the following Internet address: http://devedge.netscape.com/docs/manuals/proxy/adminux/revpxy.htm (“Payer reference”) describes the architecture of the “reverse proxy”, which involves the use of layer 7 requests received particularly for load distribution, that is to say request messages intended for an application server program in the application layer. Such a message transmitted from a client computer via a telecommunications network to the web server is first received by a reverse proxy computer, is decoded there until the message is decoded on the basis of the protocol used in the application layer, and is then forwarded directly to an available application server, that is to say to a server which provides the respective desired application server program, hence preferably a web server. This is done such that the decoded message is immediately coded again on the basis of the application layer communication protocol used, and is then transferred to the further communication layers so that it is transmitted to the web server in this manner.

One aspect of the invention is thus based on the problem of protecting an application server program against attacks which are coded in a message on the basis of an application layer protocol.

### SUMMARY OF THE INVENTION

The problem is solved with the proxy unit, the method for the computer-assisted protection of an application server program, and by the system having a proxy unit and a unit for executing an application server program.

A proxy unit has a telecommunications-network-end input interface. Via, that is to say (expressed another way) using, the input interface, it is possible to receive application-layer-coded messages.

A proxy unit is to be understood to mean both an independent hardware unit, that is to say an independent proxy computer, for example, and a computer program which provides the functionality of the proxy unit at the level of the application layer.

In this connection, telecommunications-network-end is to be understood to mean that the input interface of the proxy unit will use the proxy unit to receive messages which are sent from a client computer via the telecommunications network, for example the Internet, to an application server, that is to say a server for the application server program which is to be protected, before the respective message sent to the application server program is forwarded thereto.

In addition, the proxy unit has a decoding unit for decoding the received application-layer-coded message on the basis of an application layer protocol format, for example in the case of a WWW server program as an application server program based on the HTTP protocol format. If, as an application server program, an e-mail server program is protected, for example, then in this context the decoding unit is set up such that the message is decoded on the basis of the SMTP (Simple Mail Transfer Protocol), for example. The message decoded using the decoding unit is then available in plain text, preferably coded on the basis of the ASCII standard.

The input side of the decoding unit is coupled to the input interface, and the output side of the decoding unit is connected to a filter which is used to filter out a received message if it satisfies a prescribed attack test criterion.

In this connection, an “attack test criterion” is to be understood to mean an information element which is used to identify that the message is a message which is intended to be used to carry out an attack on the application server program using the application protocol format.

Expressed another way, the filter in the proxy unit is thus used to subject each message to a check and to possible filtering, that is to say to exclusion for forwarding to the application server program, the test being performed on the topmost layer of the communication layer model, hence preferably on the application layer.

In addition, the filter serves to provide a coding unit for coding an unfiltered message to produce a proxy-application-layer-coded message on the basis of the application layer protocol format.

The coding unit is thus used to code the messages regarded as being nonhazardous which do not satisfy the attack test criterion on the basis of the application layer protocol format again and on the basis of the protocol formats for the layers situated below and to supply them to a computer-network-end output interface, that is to say (expressed another way) to an output interface which is coupled to the application server itself and hence to the application server program. The output interface is used to transfer the proxy-application-layer-coded message to the application server program which is to be protected.

In a method for the computer-assisted protection of an application server program, an application-layer-coded message is received in a proxy unit and the received application-layer-coded message is decoded on the basis of an application layer protocol format. The decoded message is then checked to determine whether it satisfies at least one prescribed attack test criterion. If the message satisfies the attack test criterion, then the message is not forwarded to the application server program. The message can thus either be rejected or can be returned to the sender directly. In addition, in this case, an alarm can be generated, so that a user or a network manager is informed about the attempted attack at the level of the application layer.

The decoded message, which does not satisfy the prescribed attack test criterion, however, is in turn coded on the basis of the application layer protocol format used and is then transmitted to the application server program, possibly following coding on the basis of the protocol formats which are used for the other communication layers arranged below the application layer.

A system having a proxy unit and a unit for executing an application server program contains a proxy unit which has the elements described above. In addition, an application server program is provided in which the decoded proxy-application-layer-coded message can be processed.

The above forms a firewall which provides a check on the transmitted messages at the level of the application layer, that is to say the topmost communication layer in the communication layer model.

The method, proxy unit and system invention avoids, for the first time, directly installing a patch program on the application server program's respective server in order to eliminate the weaknesses.

It is thus possible to install update programs for the application server program at normal maintenance intervals; this no longer needs to be done on an extraordinary basis.

In addition, the certification of an application server program is maintained according to one aspect of the invention.

The method, proxy unit and system ensure protection of the application server program for the application server, even if there is no patch program available.

It is also no longer necessary to turn off a system for appropriate security reasons, to the same extent as it is not necessary to restrict the communication between the application server programs communicating with one another.

In addition, the messages can be checked very easily and hence at a very high-performance level, since the check is run for characters which are coded in ASCII format—expressed another way, on the check on directly coded character strings.

Another advantage can be seen in the scaling, that is to say—expressed another way—in that only one computer, namely the computer with the proxy unit, is necessary in order to protect a basically arbitrary number of servers for the respective application server program.

In accordance with one refinement, the filter is set up such that it is used to filter out a received message whose message length is greater than a prescribed threshold value.

In accordance with an alternative refinement, a pattern store is provided which stores at least one prescribed test pattern, and the filter is set up such that it is used to filter out a received message which contains the at least one test pattern.

The refinements described above can clearly be regarded as refinements of the filter which provides identification of various known prescribed attack patterns, based on, by way of example,

character strings (strings, that is to say signatures),

the length of a message or a request to the application server program on the basis of the application layer protocol format used (for example to protect against “buffer overflow”), and

checks on the syntax, that is to say identification and avoidance of format string attacks.

In accordance with another refinement, the pattern store stores a plurality of test patterns, and the filter is set up such that a received message is filtered out if it contains at least one of the test patterns.

On the basis of these refinements, very simple options are indicated for identifying and preventing ordinary attacks at the level of the application layer.

In addition, the at least one test pattern can be an attack pattern of message elements, the attack pattern being able to be used for an attack on the application server program.

In accordance with another refinement, the proxy unit has a key store for storing cryptographic keys, preferably for storing the asymmetric or symmetric cryptographic keys used by the respective communication partners within the context of electronic commerce. In addition, a decryption unit is provided for decrypting a received encrypted message using one of the stored cryptographic keys, that is to say particularly using the secret key associated with the receiver of the message. In accordance with this refinement, the decrypted message can then be supplied to the filter for checking at the level of the application layer.

This development allows the proxy unit also to be used within the context of an application server program protected by a cryptographic security architecture, for example a WWW server program which uses the SSL protocol to provide cryptographically protected communication.

In accordance with this refinement, provision can also be made for an encryption unit to be able to be used to encrypt an unfiltered message in the case of asymmetric encryption using the public key associated with the respective communication partner and in the case of symmetric encryption using the respective symmetric session key. In this case, the encrypted message can be supplied to the output interface.

The proxy unit and the application server program can be installed on the same computer or else on different computers.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a sketch of a communications system having a proxy unit in accordance with a first exemplary embodiment of the invention;

FIG. 2 shows a sketch in which the flow of messages is illustrated on the basis of the exemplary embodiments of the invention; and

FIG. 3 shows a sketch of a communications system based on a second exemplary embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

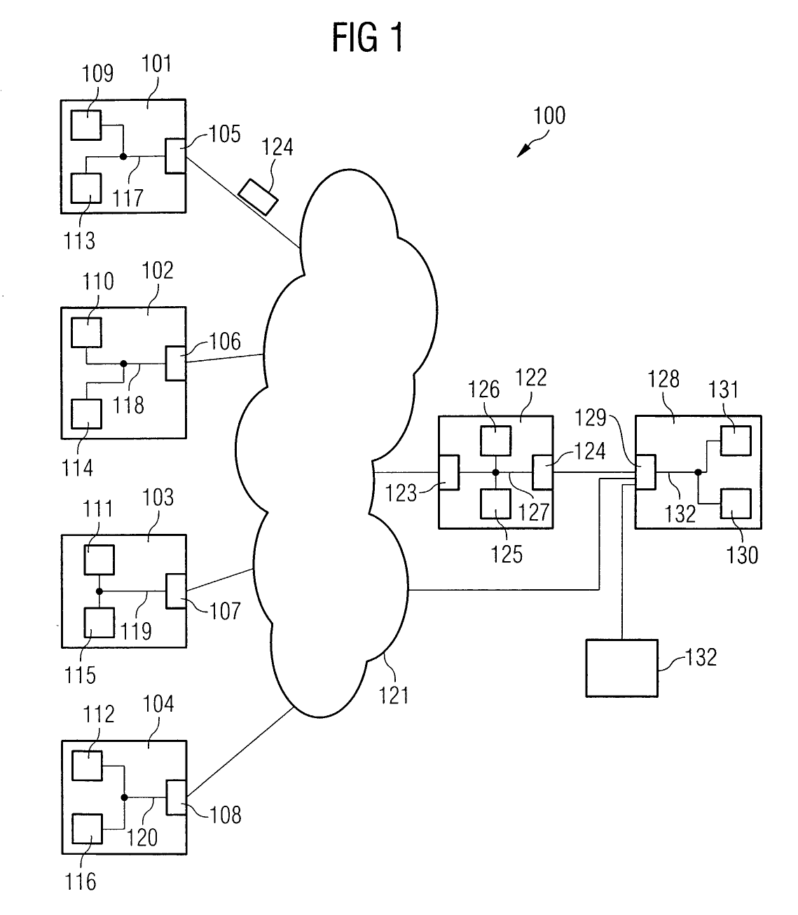

FIG. 1 shows a communications system 100 based on a first exemplary embodiment of the invention.

The communications system 100 has a multiplicity of client computers 101, 102, 103, 104, each client computer 101, 102, 103, 104 having a respective input/output interface 105, 106, 107, 108 and a respective processor 109, 110, 111, 112 and a memory 113, 114, 115, 116.

Each memory 113, 114, 115, 116 in a respective client computer 101, 102, 103, 104 stores a respective WWW browser program, for example Internet Explorer™ or Netscape™ Communicator™. The respective browser program is executed by the processor 109, 110, 111, 112.

The input/output interface 105, 106, 107, 108 of a respective client computer 101, 102, 103, 104 and the memories 113, 114, 115, 116 and the processors 109, 110, 111, 112 are respectively coupled to one another via a computer bus 117, 118, 119, 120.

The client computers 101, 102, 103, 104 are coupled to a proxy computer 122—expressed in more precise terms, to an input/output interface 123 of the proxy computer 122—via the Internet 121 as a telecommunications network. The proxy computer 122 also has, besides the telecommunications-network-end input/output interface 123, a server-end input/output interface, subsequently also referred to as computer-network-end input/output interface 124. In addition, the proxy computer 122 has a memory 125 and a processor 126 which are coupled to one another and to the two input/output interfaces 123, 124 via a computer bus 127.

The memory in the proxy computer 122 stores, firstly, the cryptographic keys, particularly the secret keys associated with the users of the WWW server program on the server computer 123, which will be explained in more detail below, in a preferably individually cryptrographically protected memory area referred to as a key store. A further memory area, also referred to below as a pattern store, stores prescribed test patterns, the significance of which will be explained in more detail later.

The memory also stores a program which implements the proxy unit and which processes incoming messages in the proxy computer 122, as explained in detail below.

A client computer 101, 102, 103, 104 transmits an electronic message, in accordance with this exemplary embodiment a Get request, coded on the basis of the HTTP communication protocol, to the server computer 128 via the Internet, using the TCP (transport control protocol)/IP (Internet protocol) protocol stack, as a request to reproduce information from information provided to the server computer 128.

In this connection, it should be noted that, in an alternative embodiment, the electronic message is not generated using a WWW browser program, but rather only the syntax based on the application protocol format is used, without the need for a WWW browser program to be installed on the client computer 101, 102, 103, 104. This is the case particularly when the client is an attack program.

The server computer 128 is coupled to the server-end input/output interface 124 of the proxy computer 122 via an input/output interface 129 and has a memory 130 and a processor 131 which are coupled to one another and to the input/output interface 129 via a computer bus 132.

In addition, a screen 132 is coupled to the server computer 128 via the input/output interface 129.

The memory 130 in the server computer 128 stores a WWW server program. In addition, the memory 130 stores the information provided to the client computers 101, 102, 103, 104 in the form of, by way of example, a home page and provided information which is arranged hierarchically thereunder. The information can be text information, still picture information, video information or else audio information.

In accordance with this exemplary embodiment, communication thus takes place on an application layer on the basis of the HTTP protocol format.

With reference to figure, the principle on which the proxy unit, method and system are based is described below on the simple assumption that the first client computer 101 sends an HTTP request to the web server.

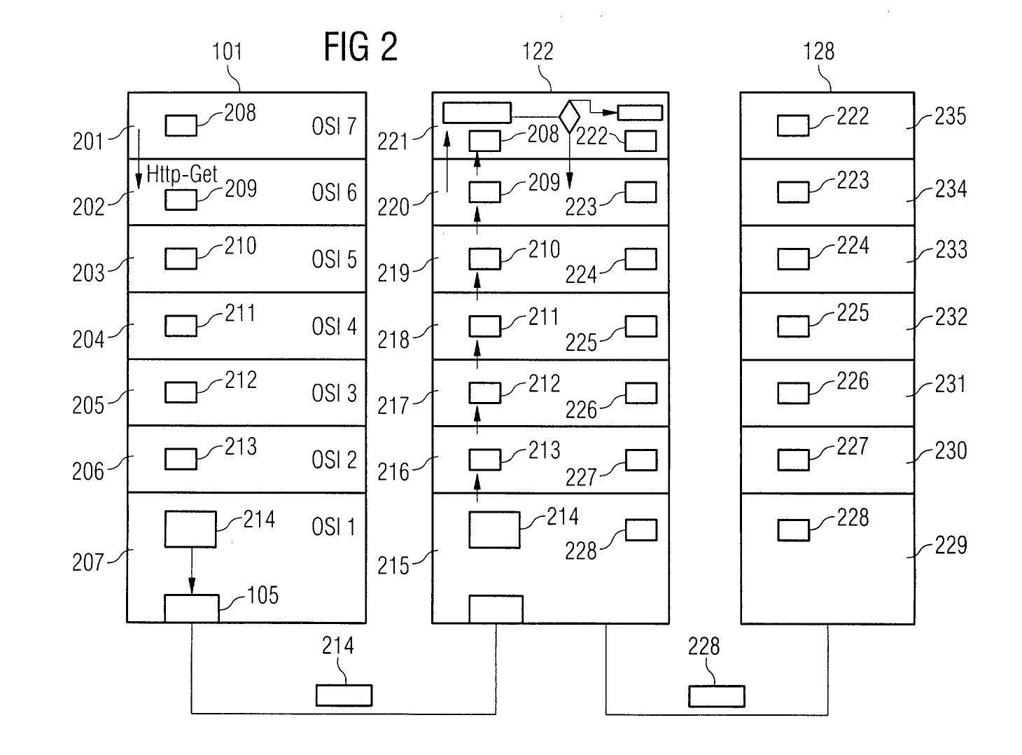

FIG. 2 shows the individual communication layers symbolically for the first client computer 101, that is to say

the application layer 201,

the presentation layer 202,

the session layer 203,

the transport layer 204,

the network layer 205,

the data link layer 206, and

the physical layer 207.

A browser program request, that is to say, in accordance with this exemplary embodiment, an HTTP Get message 208, is transmitted from the application layer 201, that is to say, in accordance with the preferred exemplary embodiment, from the browser program on the first client computer 101, to the elements in the presentation layer and is coded there on the basis of the implemented layer 6 protocol, that is to say on the basis of the presentation layer protocol, to form a presentation-layer-coded message 209 and is supplied to the session layer 203, where it is coded to form a session-layer-coded message 210.

The session-layer-coded message 210 is supplied to the transport layer 204 and is coded there on the basis of the transport control protocol (TCP) to form a transport-layer-coded message 211.

The message 211 coded on the basis of the TCP is supplied to the network layer 205 and is coded there on the basis of the Internet protocol (IP) to form a network-layer-coded message 212.

The network-layer-coded message 212 is in turn supplied to the data link layer 206 and is coded there on the basis of the protocol used in the data link layer 206 to form a data-link-layer-coded message 213.

Finally, the first client computer 101 supplies the data-link-layer-coded message 213 to the physical layer 207, where it is channel coded on the basis of the transmission method used to form a physical-layer-coded message 214 which is transmitted to the proxy computer 212 via the telecommunications network, that is to say the Internet 121.

In line with the previously described method of coding, the physical layer 215 in the proxy computer 122 decodes the received message on the basis of the protocol used in the physical layer 215 to form the data-link-layer-coded message 213, which is supplied to the data link layer 216 in the proxy computer 122.

In the data link layer 216, the data-link-layer-coded message 213 is decoded on the basis of the protocol for the data link layer 216, and the user data obtained therefrom are supplied as a network-layer-coded message 212 to the network layer 217 in the proxy computer 122, where they are decoded in turn on the basis of the protocol for the network layer 217, that is to say, in accordance with this exemplary embodiment, on the basis of the Internet protocol.

The user data in the network layer 217 which are ascertained on the basis of the decoding are supplied as a transport-layer-coded message 211 to the transport layer 218 in the proxy computer 122, where they are decoded on the basis of the TCP format to form the session-layer-coded message 210, which is supplied to the session layer 219 in the proxy computer 122 and is decoded there on the basis of the protocol used in the session layer 219.

The user data ascertained thereby produce the presentation-layer-coded message 209 and are decoded in the presentation layer 220 in the proxy computer 122 on the basis of the communication protocol used in layer 6. Following decoding, the user data obtained therefrom are the originally coded application-layer-coded message 208, which is supplied to the application layer 221 in the proxy computer 122 and is decoded there on the basis of the HTTP.

The resultant user data are now in the ASCII format and are subjected to a check as explained below.

In this connection, it should be noted that the method and device allow individual communication layers to be provided as well within the context of communication, and the functionality thereof can be split over other layers on the basis of the OSI reference model. The only point of importance is that the subsequently described filtering of the data is done in the proxy computer 122 on the topmost communication layer, the application layer.

The check can be carried out in various ways.

A first option is for every application-layer-decoded message 208 to be checked to determine whether it contains a prescribed length of characters, in order to prevent a possible buffer overflow on the part of the server computer 128 in this manner.

Alternatively or in addition, it is possible to perform a comparison with prescribed test patterns, as are stored in the pattern store in the proxy computer 122.

The test patterns represent known attack patterns which exploit known security gaps in the respectively used application server program, in accordance with this exemplary embodiment the respective browser program.

The text below shows, by way of example, a few test patterns against which the character string in the application-layer-decoded message is tested. The test patterns are grouped into test pattern example groups, with the test patterns in the individual test pattern example groups each representing attack patterns for particular weaknesses in the application server program:

[image]

[image]

[image]

[image]

[image]

[image]

[image]

[image]

[image]

[image]

[image]

[image]

Clearly, a character string comparison is made between the decoded message and the respective stored test pattern.

If the character strings in the decoded message and in a test pattern match, then this means that the original application-layer-coded message has an attack code, that is to say clearly an attack pattern, which is intended to be used to start an attack on the WWW server program on the web server 128.

In this case, the decoded message is not transmitted on to the server computer 128, but rather an alarm report is generated and is output to the network administrator. Alternatively, in such a case, the decoded message can also simply be rejected. In addition, the sender of the decoded message can alternatively be sent an announcement indicating that the decoded message has been identified as a message containing an attack pattern.

If the character strings do not match, however, that is to say if the character string or part of the character string in the application-layer-decoded message 208 does not match at least one of the stored attack patterns, then this means that the WWW server program request 208 is permissible and is not a danger to the server computer 128, that is to say, expressed more precisely, to the application server program on the server computer 128.

In this case, the application layer 221 in the proxy computer 122 codes the decoded message 208 on the basis of the application layer's protocol again, in accordance with this exemplary embodiment on the basis of the HTTP protocol format, to form a proxy-application-layer-coded message 222 which is supplied to the presentation layer 220, where it is coded further to form a proxy-presentation-layer-coded message 223.

The proxy-presentation-layer-coded message 223 is supplied to the session layer 219 in the proxy computer 122 and is coded there to form a proxy-session-layer-coded message 224 and is supplied to the transport layer 218, where it is coded on the basis of the TCP to form a proxy-transport-layer-coded message 225.

The proxy-transport-layer-coded message 225 is supplied to the network layer in the proxy computer 122 and is coded there on the basis of the IP to form a proxy-network-layer-coded message 226.

The proxy-network-layer-coded message 226 is supplied to the data link layer 216 and is coded there on the basis of the protocol used in the data link layer 216 to form a proxy-data-link-layer-coded message 227, and it is then supplied to the physical layer 215, where it is coded on the basis of the protocol used in the physical layer to form a proxy-physical-layer-coded message 228 and is transmitted to the server computer 128 via the server-end computer network, for example a local computer network (local area network).

The server computer 128 likewise has, in turn, the corresponding elements in the communication layers, and the physical layer 229 in the server computer 128 decodes the proxy-physical-layer-coded message 228 at the server end.

The resultant, decoded user data are supplied to the data link layer 230 and are decoded again there.

The resultant proxy-network-layer-coded message 226 is supplied to the network layer 231 and is decoded on the basis of the Internet protocol. The resultant user data produce the proxy-transport-layer-coded message 225, which is supplied to the transport layer 232 in the server computer and is decoded further there on the basis of the TCP.

The resultant proxy-session-layer-coded message 224 is supplied to the session layer 233 in the server computer 128 and is decoded there on the basis of the protocol for the session layer 233.

The user data ascertained as a result of the decoding produce the proxy-presentation-layer-coded message 223 and are supplied to the presentation layer 234.

Following decoding, the proxy-application-layer-coded message 222 is now ascertained, which is supplied to the browser program on the server computer 128 in the application layer 235 and is processed there. Expressed another way, this means that the now decoded HTTP Get request supplied to the web server program on the server computer 128 can be processed, and the requested information on the first client computer 101 is coded in a correspondingly inverse manner, as described above, and is transmitted to the first client computer 101 via the Internet.

In accordance with this exemplary embodiment, the requested data transmitted to the first client computer 101 are likewise transmitted via the proxy computer 122 on the basis of the respectively used communication protocols.

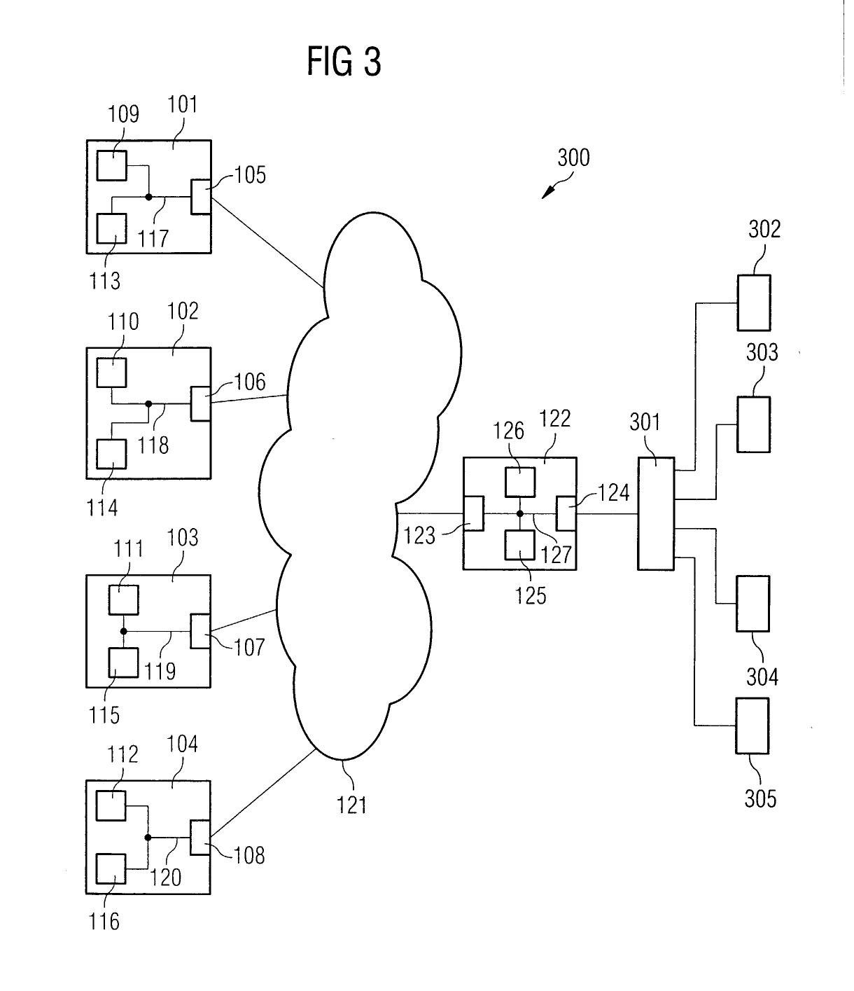

FIG. 3 shows an alternative embodiment of a communications system 300 based on a second exemplary embodiment of the invention.

The structure based on the second exemplary embodiment is very similar to the structure of the communications system 100 from the first exemplary embodiment and basically differs merely in that a reverse proxy 301 is interposed downstream of the proxy computer 122, that is to say in the server-end communication direction, in order to distribute the load from incoming HTTP Get requests over a multiplicity of application servers 302, 303, 304, 305.

The communications system 300 according to the second exemplary embodiment is thus clearly based on the architecture described in Payer reference for a reverse proxy having an upstream proxy unit 122 .

In this connection, it should be noted that, for the situation in which a particular patch prevents a known attack with the corresponding attack patterns, these attack patterns can be deleted in the pattern store and this corresponding protective mechanism and the associated protective filter can be turned off.

In accordance with one alternative refinement, provision is made for the browser program, that is to say the Internet browser, and the WWW server program to use an encryption mechanism, for example based on the secure sockets layer described in '390 patent.

In this case, the proxy unit 122 contains a respective encryption and decryption unit for decrypting the correspondingly encrypted data, in order in this manner to apply the test, that is to say the filter mechanism, to the unencrypted application-layer-decoded messages and then in turn to transmit the data to the server computer 128 in encrypted fashion using the respective keys stored in the key store on the proxy computer 122. In this way, the transmission of confidential data within the context of an e-commerce transaction is also ensured.

It should also be noted that the proxy computer does not absolutely have to be provided as a separate computer, but rather can also be integrated in the server computer 128 as a proxy unit, in which case, however, it is necessary to ensure that every incoming message which is sent to the application server program to be protected on the server computer 128 is first subjected to the filter mechanism in the proxy unit.

The invention has been described in detail with particular reference to preferred embodiments thereof and examples, but it will be understood that variations and modifications can be effected within the spirit and scope of the invention.

What is claimed is:

1. A proxy unit, comprising:
a telecommunications-network-end input interface to receive an application-layer-coded message,
a decoding unit to code the application-layer-coded message received at the input interface, on the basis of an application layer protocol format, the decoding unit producing a decoded message,
a filter to filter out the decoded message if the decoded message satisfies at least one prescribed attack test criterion, the filter outputting the decoded message as an unfiltered message if the decoded message does not satisfy an attack test critereon,
a coding unit to code the unfiltered message to produce a proxy-application-layer-coded message on the basis of the application layer protocol format, and
a computer-network-end output interface to transmit the proxy-application-layer-coded message to an application server program.

2. The proxy unit as claimed in claim 1, wherein the filter filters out the received message if the received message has a message length greater than a prescribed threshold value.

3. The proxy unit as claimed in claim 1, wherein
the proxy unit further comprises a pattern storage unit containing at least one prescribed test pattern, and
the filter filters out the received message if the received message contains the at least one test pattern.

4. The proxy unit as claimed in claim 3, wherein
a plurality of test patterns are stored in the pattern storage unit, and
the filter filters out the received message if the received message contains at least one of the test patterns.

5. The proxy unit as claimed in claim 3, wherein the at least one test pattern is an attack pattern of message elements, which attack pattern can be used for an attack on the application server program.

6. The proxy unit as claimed in claim 1, wherein
the proxy unit further comprises:
a key storage unit to store cryptographic keys, and
a decryption unit for decrypting a received encrypted message using one of the stored cryptographic keys and producing a decrypted message, and the decrypted message is supplied to the filter.

7. The proxy unit as claimed in claim 1, wherein
the proxy unit further comprises an encryption unit for encrypting an unfiltered message and producing an encrypted message, and
the encrypted message is supplied to the output interface.

8. The proxy unit as claimed in claim 4, wherein the at least one test pattern is an attack pattern of message elements, which attack pattern can be used for an attack on the application server program.

9. The proxy unit as claimed in claim 8, wherein
the proxy unit further comprises:
a key storage unit to store cryptographic keys, and
a decryption unit for decrypting a received encrypted message using one of the stored cryptographic keys and producing a decrypted message, and the decrypted message is supplied to the filter.

10. The proxy unit as claimed in claim 9, wherein
the proxy unit further comprises an encryption unit for encrypting an unfiltered message and producing an encrypted message, and
the encrypted message is supplied to the output interface.

11. A method for computer-assisted protection of an application server program, comprising:
receiving an application-layer coded message at a proxy device,
decoding the application-layer-coded message received at the proxy device on the basis of an application layer protocol format to thereby produce a decoded message,
checking whether the decoded message satisfies at least one prescribed attack test criterion,
coding the decoded message on the basis of the application layer protocol format for the application layer to thereby produce a coded message, and
transmitting the coded message to the application server program only if the prescribed attack test criterion has not been satisfied.

12. A system comprising:
a proxy unit comprising:
a telecommunications-network-end input interface to receive an application-layer-coded message,
a decoding unit to code the application-layer-coded message received at the input interface, on the basis of an application layer protocol format, the decoding unit producing a decoded message,
a filter to filter out the decoded message if the decoded message satisfies at least one prescribed attack test criterion, the filter outputting the decoded message as an unfiltered message if the decoded message does not satisfy an attack test critereon,
a coding unit to code the unfiltered message to produce a proxy-application-layer-coded message on the basis of the application layer protocol format, and
a computer-network-end output interface to transmit the proxy-application-layer-coded message to an application server program; and
an execution unit containing the application server program and a processor to process the proxy-application-layer-coded message using the application server program.

13. The system as claimed in claim 12, wherein the proxy-application-layer-coded message is decoded before being processed by the processor.

14. The system as claimed in claim 12, wherein the proxy device and the execution unit are implemented on different computers.
